(19) United States
(12) Patent Application Publication
(10) Pub. No.: US 2009/0254607 A1
(43) Pub. Date: Oct. 8, 2009

(54) CHARACTERIZATION OF CONTENT DISTRIBUTED OVER A NETWORK

(75) Inventor: Gary M. Zalewski, Oakland, CA (US)

Correspondence Address: JOSHUA D. ISENBERG;JDI PATENT, 809 CORPORATE WAY, FREMONT, CA, 94539, US

(73) Assignee: Sony Computer Entertainment America Inc., Foster City, CA (US)

(21) Appl. No.: 12/099,082

(22) Filed: Apr. 7, 2008

(51) Int. Cl. G06F 15/16

(52) U.S. Cl. 709/203

(57) ABSTRACT

A client device, a computer implemented method for modifying content for a media player associated with the client device, a content characterization server, a computer implemented method for characterizing content for a media player associated with a client device, as well as a system and method involving the client device and content characterization server are disclosed.

### FIELD OF THE INVENTION

This invention is related to media and advertising and more particularly to characterizing content that is distributed over a network before the content is downloaded at a client device.

### BACKGROUND OF THE INVENTION

A wide variety of multimedia content is currently available to consumers, and new content streams are being developed. Multimedia content ranges from low-bandwidth, unidirectional data streams such as low-fidelity audio-only content, through high-bandwidth, bi-directional data streams that support interactive, real-time, virtual game environments. Many consumer devices and services are available to generate, present, transform, store, replay and otherwise manipulate multimedia streams. Televisions, digital video recorders (“DVRs”), game consoles, cable television receivers, Video On Demand (“VOD”) services and even cellular telephones are capable of providing rich media experiences for consumers.

Traditionally, certain media streams have been supported by revenue from companies that advertise their products and services during “commercial breaks.” However, many consumers prefer to avoid commercials by switching to a different media channel during a commercial break, or by fast forwarding through commercials that appear in a recorded stream.

Commonly-assigned U.S. patent application Ser. No. 11/756,508 to Riley R. Russell and Gary M. Zalewski, filed May 31, 2007 and entitled “SYSTEM AND METHOD FOR TAKING CONTROL OF A SYSTEM DURING A COMMERCIAL BREAK” describes a method and system that automatically, on detection of a signal or indication of a commercial break causes a context switch to enable other services, programming or devices to gain control of the output of a display, speaker, process or system during the period of the commercial break then rejoin with the original programming context when the commercial break is over. The system proposed in that application analyzes the content after it has been downloaded to a user's display device, e.g., a television or multimedia system. However, content streams can be quite large and multimedia systems may have limited memory, storage and processing capacity to analyze large content streams. Thus, a user's system may not be capable of analyzing the content stream fast enough to determine when a break begins and ends.

It is within this context that embodiments of the invention arise.

### BRIEF DESCRIPTION OF THE DRAWINGS

The teachings of the present invention can be readily understood by considering the following detailed description in conjunction with the accompanying drawings, in which:

FIG. 1 is a schematic diagram of a content characterization distribution system according to an embodiment of the present invention.

FIG. 2 is a flow diagram illustrating characterization of network-distributed content according to an embodiment of the present invention.

FIG. 3 is a block diagram illustrating a client device according to an embodiment of the present invention.

FIG. 4 is a block diagram illustrating a content-characterization server according to an embodiment of the present invention.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

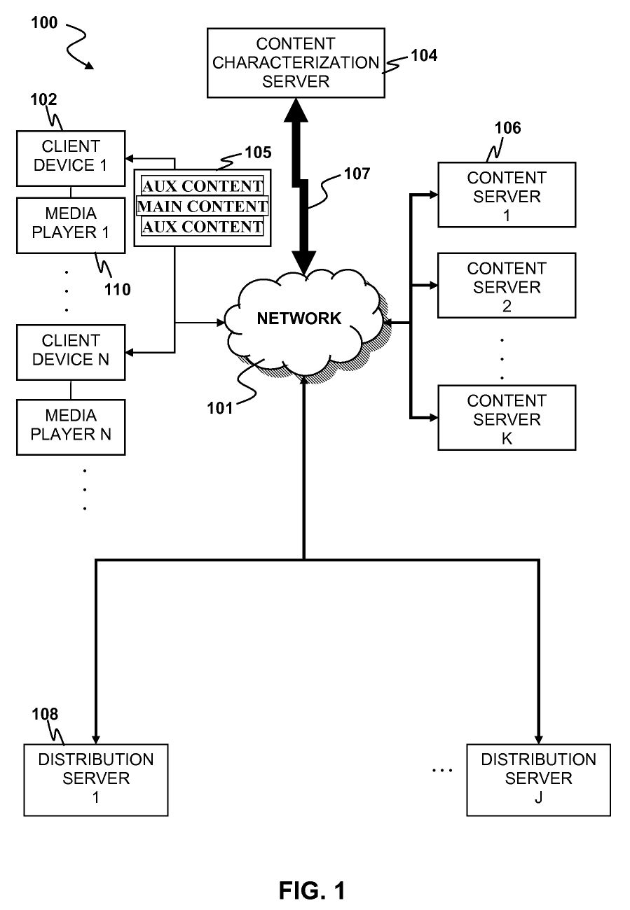

As seen in FIG. 1 a content characterization system 100 may include one or more client devices 102 and a content characterization server 104. The client devices 102 and content characterization server 104 may be configured to communicate over a network 101. By way of example, and without loss of generality, the network 101 may be a bi-directional digital communications network. The network 101 may be a local area network or wide area network such as the Internet. The network 101 may be implemented, e.g., using an infrastructure, such as that used for CATV bi-directional networks, ISDN or xDSL high speed networks to enable network connections for implementing certain embodiments of the present invention.

By way of example, and without limitation, the client devices 104 may be game consoles. Examples of commercially game consoles include the Xbox® from Microsoft Corporation of Redmond Wash., the Wii® from Nintendo Company, Ltd of Kyoto, Japan and PlayStation® devices, such as the PlayStaion3 from Sony Computer Entertainment of Tokyo, Japan. Xbox® is a registered trademark of Microsoft Corporation of Redmond, Wash. PlayStation® is a registered trademark of Kabushiki Kaisha Sony Computer Entertainment of Tokyo, Japan. Wii® is a registered trademark of Nintendo Company, Ltd of Kyoto, Japan. Alternatively the client devices may be any other type of network capable device that can receive and use auxiliary content. Such devices include, but are not limited to cellular telephones, personal computers, laptop computers, television set-top boxes, portable internet access devices, portable email devices, portable video game devices; personal digital assistants, digital music players and the like. Furthermore, the client devices 104 may incorporate the functions of two or more of the devices in the examples previously listed.

In some embodiments, items of content 105 may be distributed over the network 101 by one or more remote content servers 106. As used herein, the term “item of content” generally refers to works of authorship that can be interpreted by the client devices 102 and content characterization server 104. Such works may be in digital form suitable for distribution over a network. Examples of such works include, but are not limited to, movies and videos, musical works, and the like. Each client device 102 may have a media player 110 associated with it. The media player 110 is configured to present the content item 105, e.g., on a video display or audio system. Examples of media players include digital video players, digital audio players and the like. The media player 110 may be physically incorporated into the client device 102 or connected to it, e.g., by cable or wireless link. Alternatively, the client device 102 and media player may be owned, rented or under the control of a common user.

The client devices 102 and content characterization server 104 may access items of content 105 from the content servers 106 via the network 101. In some embodiments, one or more distribution servers 108 may be involved in the process of obtaining items of content from the content servers 106. Specifically, a client device 102 or content characterization server 104 may first contact a distribution server 108 to determine which content server(s) contain the files that make up an item of content 105. The distribution server may then send information identifying the relevant content servers to the client device 102 or content characterization server 104. The identifying information may be in the form of a universal resource locator (URL) for the appropriate content server(s). The client device 102 or content characterization server 104 may then contact the content server(s) 106 and obtain the relevant content file(s). It is noted that in a preferred embodiment of the invention, the content characterization server may be connected to the network 101 by a high-bandwidth datalink 107. The high-bandwidth datalink 107 is characterized by a data transfer rate for downloading the content item 105 from a remote content server 106 that is greater than a data transfer rate for which the client device 102 can download the content item from the remote content server 106. In this manner, the content characterization sever 104 may obtain and characterize content items 105 faster than the client device 102 can download them.

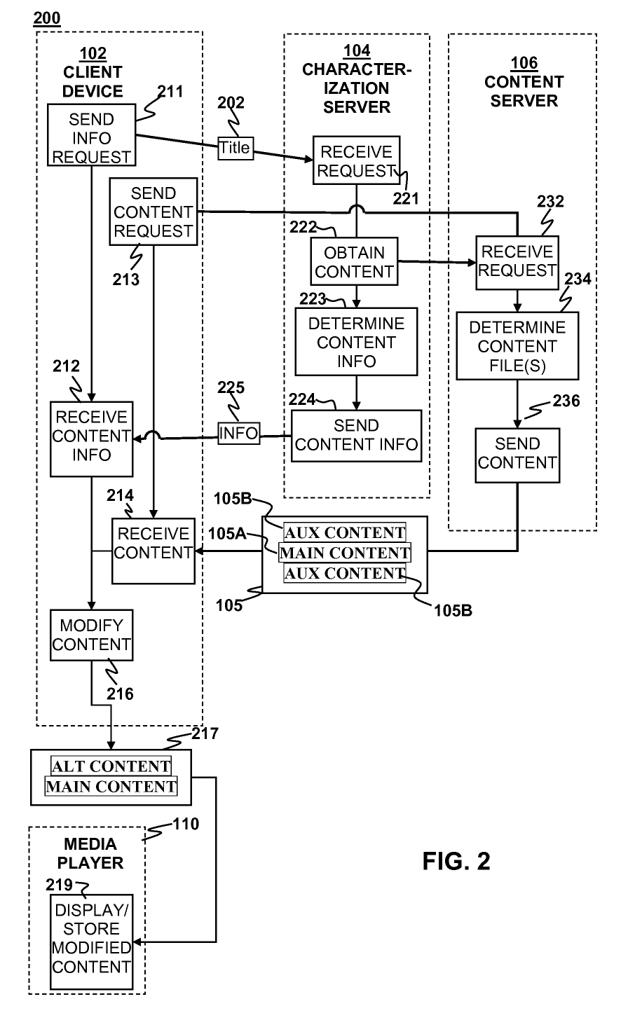

Operation of a client device 102 and content characterization server 104 in accordance with embodiments of the present invention may be understood with respect to a method 200 illustrated in FIG. 2. Each client device 102 may be configured to submit information identifying a particular item of content to the content characterization server 104. The content characterization server 104 is configured to receive the input from the client device 102. As shown in FIG. 2, the client device 102 may be configured to request content characterization information e.g., by sending content identifying information 202 to the content characterization server 104 as indicated at 211. The content identifying information may include a title for the content item 105. The content characterization server 104 may be configured to receive the content identifying information 202 from the client device 102 as indicated at 221. The content characterization server 104 may be further configured to obtain the content item 105 as indicated at 222. By way of example, and without loss of generality, the content characterization server 104 may send a request for content to a content server 106. The content server 106 may receive the request for the content item over the network 101 as indicated at 232, determine the relevant content files or files for the content item 105 as indicated at 234 and send the content items over the network 101, as indicated at 236. Alternatively, the content characterization server 104 may have pre-stored the content item 105 in a local storage device associated with the content characterization server. In such a case, the content characterization server 104 may obtain the relevant content files from the local storage device.

Once the content item 105 has been obtained, the content characterization sever 104 may analyze the content item 105 as indicated at 223 to produce content characterization information 225 associated with the content item, and send the information to the client device 102 as indicated at 224. By way of example the content item 105 may include a main feature 105A and one or more auxiliary features 105B. As used herein, the term auxiliary feature means a portion content, e.g., in the form of text, still images, video images, animations, sounds, applets, three-dimensional content, etc, that is provided gratuitously along with a main content item. Examples of auxiliary content include advertisements, public service announcements, software updates, interactive game content and the like. The auxiliary content may appear at one or more pre-defined locations or instances of time during the course of presentation of the content item 105 by the media player 110.

By way of example, the main content feature 105A may be a movie, video, audio or musical performance that a user was motivated to download and the auxiliary content feature 105B may include one or more gratuitously provided advertisements that are interspersed with sections of the main content feature 105A. In such a case, the content characterization server 104 may identify a division between a main feature 105A the auxiliary feature(s) 105B and include this information in the content characterization information 225. Thus, the content characterization information 225 may identify divisions between the main feature 105A and the auxiliary feature(s) 105B. By way of example, the content characterization information 225 may include a listing timestamps indicating the start and end of each auxiliary content feature 105B. By way of example, the start and end of a commercial break may be identified, e.g. as described in U.S. Pat. No. 7,184,649, which is incorporated herein by reference or as set forth in PCT Publication WO/2003/061280, which is incorporated herein by reference.

In an alternative embodiment, the content characterization server 104 may associate a moderation criterion with a particular portion of the content item 105. In such a case, the content characterization information 225 may include the content moderation criterion and its association with the particular portion of the content item. As used herein, the term “moderation criterion” refers to a measure of the appropriateness of the content based on some legal, community-defined, or user-defined standard. Examples of such moderation criteria may include ratings of certain portions of the main feature 105A (or auxiliary feature(s) 105B) based on such factors as, violence, adult language or adult content in particular portions. By way of example, the content characterization server 104 may analyze an audio portion of a movie to determine if certain offensive words are spoken in particular portions of the content item 105. The content characterization may then determine time stamps marking the utterance of a particular offensive word in the content item 105. In some cases, the originator of the content item 105 may provide timestamps marking the beginning and ending of portions containing violence or adult content. The content characterization server 104 may include these time stamps along with information specifying the nature of the particular portions. For example, in the case of the use of offensive language, the content characterization server 104 may include text or other data indicating “offensive language” with the timestamps for each offensive utterance in the content characterization information 225.

Once the content item 105 has been analyzed, the content characterization server 104 may and send the content characterization information 225 to the client device 102. The client device 102 may be further configured to receive the content characterization information 225 from the content characterization server 102 as indicated at 212. The client device 102 may obtain the item of content 105, e.g., from one or more content servers 106 as described above. By way of example, and without loss of generality, the client device 102 may send a content request to a content server 106 as indicated at 213. The content server 106 may receive the request at 232, determine the relevant content files at 234 and send the content 105 at 236. The client device 102 may receive the content item 105 as indicated at 214. It is noted that the process of downloading the content item 105 from the content server 106 to the client device 102 may take place in parallel with downloading and analyzing the content file by the content characterization server 104.

Once the content item 105 and content characterization information 225 are received the client device 102 may modify the content item 105 as indicated at 216 based on the content characterization information 225 to produce a modified content item 217. The modified content 217 may then be sent to the media player 110, which may store and/or present the modified content as indicated at 219.

There are a number of different ways in which the client device may use the content characterization information 225 to modify the content. By way of example, and without loss of generality, suppose the content item 105 includes a main content feature 105A and an auxiliary content feature 105B, such as an advertisement. Further suppose that the content characterization information 225 includes timestamps marking the beginning of the advertisement and the end of the auxiliary content feature 105B. The client device 102 may modify the content item 105 such that the media player 110 plays the main content feature 105A but not the auxiliary content feature 105B. Specifically, the client device 102 may use the timestamps to mark the auxiliary content feature 105B in such a way that the media player 110 does not present the auxiliary content feature 105B. It is noted that this is equivalent to removing the auxiliary content feature 105B from the content item 105. In some embodiments, the client device 102 may indicate an alternative content feature, e.g., an alternative advertisement, which may be presented instead of the auxiliary content item 105B. It is noted that this is equivalent to replacing the auxiliary content feature 105B with the alternative auxiliary content feature. In some embodiments, this replacement may take place by means of a context switch, e.g., as described in commonly-assigned U.S. patent application Ser. No. 11/756,508.

In an alternative embodiment, the content characterization information 225 may include a moderation criterion and timestamps associated with a corresponding offensive portion of the content item 105, as described above. In such a case, the client device 102 may remove the offensive portion from the content item 105. By way of example, the particular portion may be “removed” by using the timestamps to indicate that the media player 110 should not present the particular portion. This is equivalent to modifying the content item 105 such that the modified content item 217 does not include the particular portion.

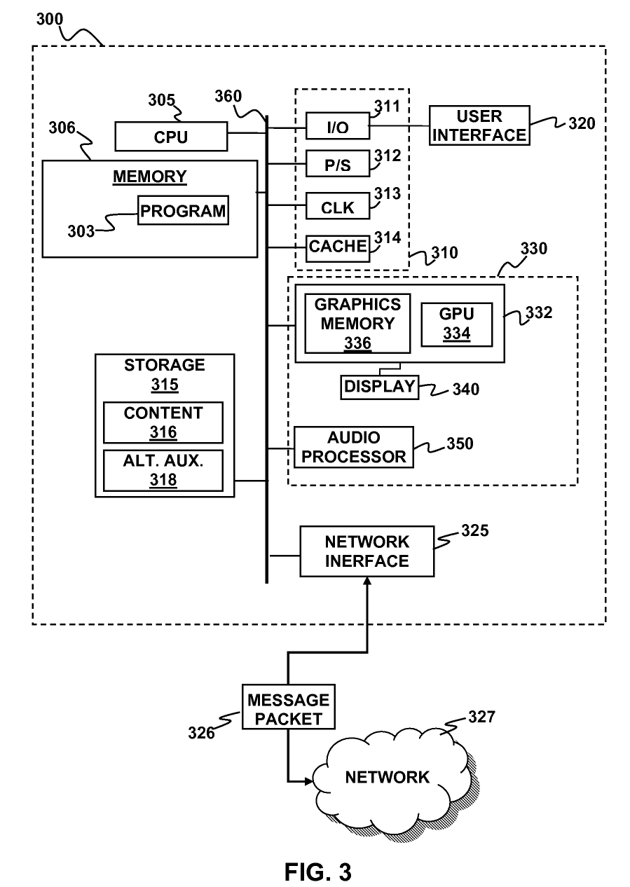

According to an embodiment of the present invention, a client device 102 may be configured to implement certain portions of the method described above with respect to FIG. 2. By way of example, FIG. 3 is a block diagram illustrating the components of a client device 300 according to an embodiment of the present invention. By way of example, and without loss of generality, the client device 300 may be implemented as a computer system, such as a personal computer, video game console, personal digital assistant, or other digital device, suitable for practicing an embodiment of the invention. The client device 300 may include a central processing unit (CPU) 305 configured to run software applications and optionally an operating system. The CPU 305 may include one or more processing cores. By way of example and without limitation, the CPU 305 may be a parallel processor module, such as a Cell Processor. An example of a Cell Processor architecture is described in detail, e.g., in Cell Broadband Engine Architecture, copyright International Business Machines Corporation, Sony Computer Entertainment Incorporated, Toshiba Corporation Aug. 8, 2005 a copy of which may be downloaded at http://cell.scei.cojp/, the entire contents of which are incorporated herein by reference.

A memory 306 is coupled to the CPU 305. The memory 306 may store applications and data for use by the CPU 305. The memory 306 may be in the form of an integrated circuit, e.g., RAM, DRAM, ROM, and the like). A computer program 303 may be stored in the memory 306 in the form of instructions that can be executed on the processor 305. The instructions of the program 303 may be configured to implement, amongst other things, certain parts of a method for modifying content for a media player associated with the client device, e.g., those portions described above as being implemented by the client device 102 in FIG. 2. By way of example, the program 303 may include instructions to send content identifying information to a content characterization server, receive content characterization information from the content characterization server, obtain the item of content from one or more content servers; and modify the item of content with the client device based on the content characterization information to produce a modified content item. The content identifying information may identify an item of content to be presented with a media player 330 associated with the client device.

The client device 300 may also include well-known support functions 310, such as input/output (I/O) elements 311, power supplies (P/S) 312, a clock (CLK) 313 and cache 314. The client device 300 may further include a storage device 315 that provides non-volatile storage for applications and data. The storage device 315 may be used for temporary or long-term storage of content items 316 downloaded from a content server as well as alternative auxiliary content items 318. By way of example, the storage device 315 may be a fixed disk drive, removable disk drive, flash memory device, tape drive, CD-ROM, DVD-ROM, Blu-ray, HD-DVD, UMD, or other optical storage devices.

One or more user input devices 320 may be used to communicate user inputs from one or more users to the client device 300. By way of example, one or more of the user input devices 320 may be coupled to the client device 300 via the I/O elements 311. Examples of suitable input device 320 include keyboards, mice, joysticks, touch pads, touch screens, light pens, still or video cameras, and/or microphones. The client device 300 may include a network interface 325 to facilitate communication via an electronic communications network 327. The network interface 325 may be configured to implement wired or wireless communication over local area networks and wide area networks such as the Internet. The client device 300 may send and receive data and/or requests for files via one or more message packets 326 over the network 327.

The media player 330 may be a component of the client device 300 that is manufactured together with the client device. Alternatively, the media player 330 may be a separate component that can inter-operate with the client device. By way of example, the media player may be a digital video player, e.g., a digital video disk (DVD) player, high-definition (HD) DVD player, Blu-Ray disk player, digital audio player, MP3 player, and the like. The media player 330 is configured to present one or more content items such as the content item 316 stored in the storage device 315. The media player 330 may comprise a graphics subsystem 332, which may include a graphics processing unit (GPU) 334 and graphics memory 336. The graphics memory 336 may include a display memory (e.g., a frame buffer) used for storing pixel data for each pixel of an output image. The graphics memory 336 may be integrated in the same device as the GPU 334, connected as a separate device with the GPU 334, and/or implemented within the memory 306. Pixel data may be provided to the graphics memory 336 directly from the CPU 305. Alternatively, the CPU 305 may provide the GPU 334 with data and/or instructions defining the desired output images, from which the GPU 334 may generate the pixel data of one or more output images. The data and/or instructions defining the desired output images may be stored in memory 310 and/or graphics memory 336. In one embodiment, the GPU 334 may be configured (e.g., by suitable programming or hardware configuration) with 3D rendering capabilities for generating pixel data for output images from instructions and data defining the geometry, lighting, shading, texturing, motion, and/or camera parameters for a scene. The GPU 334 may further include one or more programmable execution units capable of executing shader programs.

The graphics subsystem 332 may periodically output pixel data for an image from the graphics memory 336 to be displayed on a display device 340. The display device 340 may be any device capable of displaying visual information in response to a signal from the client device 300, including CRT, LCD, plasma, and OLED displays. The computer client device 300 may provide the display device 340 with an analog or digital signal. By way of example, the display 340 may include a cathode ray tube (CRT) or flat panel screen that displays text, numerals, graphical symbols or images. In addition, the display 340 may include one or more audio speakers that produce audible or otherwise detectable sounds. To facilitate generation of such sounds, the client device 300 may further include an audio processor 350 adapted to generate analog or digital audio output from instructions and/or data provided by the CPU 305, memory 306, and/or storage 315.

The components of the client device 300, including the CPU 305, memory 306, support functions 310, data storage 315, user input devices 320, network interface 325, and audio processor 350 may be operably connected to each other via one or more data buses 360. These components may be implemented in hardware, software or firmware or some combination of two or more of these.

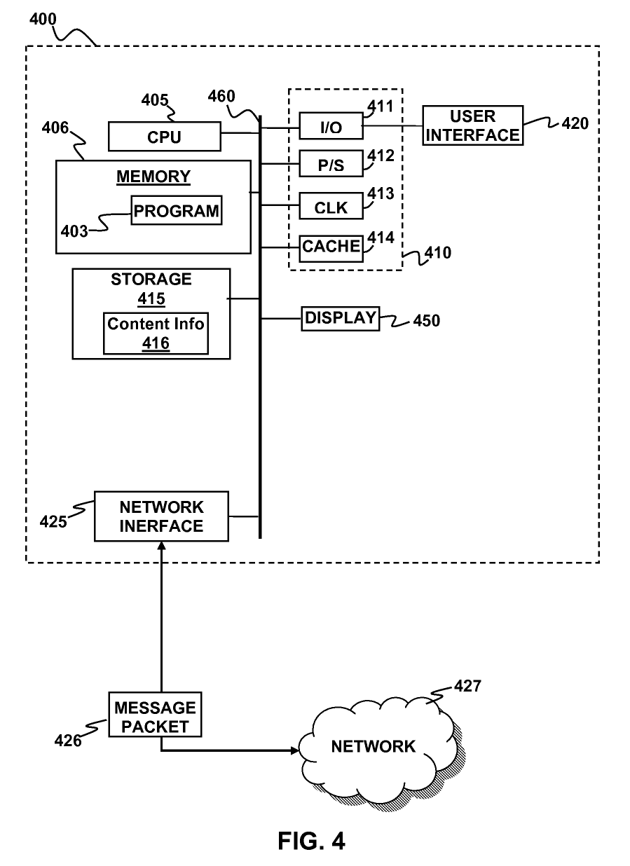

According to an embodiment of the present invention, a content characterization server 104 may be configured to implement certain portions of the method described above with respect to FIG. 2. By way of example, a content characterization server 400 may be configured as shown in FIG. 4. By way of example, and without loss of generality, the content characterization server 400 may be implemented as a computer system or other digital device. The content characterization server 400 may include a central processing unit (CPU) 405 configured to run software applications and optionally an operating system. The CPU 405 may include one or more processing cores. By way of example and without limitation, the CPU 405 may be a parallel processor module, such as a Cell Processor.

A memory 406 may be coupled to the CPU 405. The memory 406 may store applications and data for use by the CPU 405. The memory 406 may be in the form of an integrated circuit, e.g., RAM, DRAM, ROM, and the like). A computer program 403 may be stored in the memory 406 in the form of instructions that can be executed on the processor 405. The instructions of the program 403 may be configured to implement, amongst other things, certain steps of a method for characterizing content for a media player associated with a client device, e.g., those portions described above as being implemented by the content characterization server 104 in FIG. 2. Specifically, the content characterization server 400 may be configured, e.g., through appropriate programming of the program 403, to receive content identifying information from a client device, obtain the content item, analyze the content item to produce content characterization information associated with the content item, and send the content characterization information to the client device.

The content characterization server 400 may also include well-known support functions 410, such as input/output (I/O) elements 411, power supplies (P/S) 412, a clock (CLK) 413 and cache 414. The content characterization server 400 may further include a storage device 415 that provides non-volatile storage for applications and data. The storage device 415 may be used for temporary or long-term storage of content characterization information 416 such as time stamps and moderation criteria, as described above. The storage device 415 may have sufficient capacity that it can store content characterization for multiple content items 416. This allows the content characterization server 400 to download and analyze multiple content items in advance and store the content characterization information for subsequent delivery to a client device. By way of example, the storage device 415 may be a fixed disk drive, removable disk drive, flash memory device, tape drive, CD-ROM, DVD-ROM, Blu-ray, HD-DVD, UMD, or other optical storage devices.

One or more user input devices 420 may be used to communicate user inputs from one or more users to the content characterization server 400. By way of example, one or more of the user input devices 420 may be coupled to the content characterization server 400 via the J/O elements 411. Examples of suitable input device 420 include keyboards, mice, joysticks, touch pads, touch screens, light pens, still or video cameras, and/or microphones. The content characterization server 400 may include a network interface 425 to facilitate communication via an electronic communications network 427. The network interface 425 may be configured to implement wired or wireless communication over local area networks and wide area networks such as the Internet. The content characterization server 400 may send and receive data and/or requests for files via one or more message packets 426 over the network 427.

The components of the content characterization server 400, including the CPU 405, memory 406, support functions 410, data storage 415, user input devices 420, and network interface 425, may be operably connected to each other via one or more data buses 460. These components may be implemented in hardware, software or firmware or some combination of two or more of these.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A” or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. In a client device configured to interact with an interactive environment, a computer implemented method for modifying content for a media player associated with the client device, comprising:
a) sending content identifying information to a content characterization server;
b) receiving content characterization information from the content characterization server, wherein the content characterization information characterizes an item of content configured to be presented on the media player; and
c) obtaining the item of content from one or more content servers; and
d) modifying the item of content based on the content characterization information to produce a modified content item.

2. The method of claim 1, further comprising, presenting the modified content item with the media player.

3. The method of claim 1 wherein the content characterization information includes identifies a division between a main feature of the content item and an auxiliary feature of the content item.

4. The method of claim 3 wherein the auxiliary feature includes an advertisement.

5. The method of claim 3 wherein d) includes removing the auxiliary feature from the content item, whereby the modified content item does not include the auxiliary feature.

6. The method of claim 3 wherein d) includes replacing the auxiliary feature from the content item with an alternative auxiliary content item, whereby the modified content item includes the alternative auxiliary feature.

7. The method of claim 1 wherein d) includes removing a selected portion of the content item from the content item, whereby the modified content item does not include the selected portion.

8. The method of claim 1, wherein the content characterization information includes a content moderation criterion associated with a particular portion of the content item.

9. The method of claim 8 wherein d) includes removing the particular portion from the content item, whereby the modified content item does not include the particular portion.

10. The method of claim 8 wherein moderation criterion is based on a degree of violence, adult language or adult nature of the particular portion.

11. A client device, comprising:
a processor;
a memory coupled to the processor;
one or more instructions embodied in memory for execution by the processor, the instructions being configured to implement a method for modifying content for a media player associated with the client device, the method comprising:
a) sending content identifying information to a content characterization server;
b) receiving content characterization information from the content characterization server, wherein the content characterization information characterizes an item of content configured to be presented on the media player; and
c) obtaining the item of content from one or more content servers; and
d) modifying the item of content based on the content characterization information to produce a modified content item.

12. In a content characterization server, a computer implemented method for characterizing content for a media player associated with a client device, comprising:
a) receiving information from the client device, wherein the information identifies an item of content;
b) obtaining the content item;
c) analyzing the content item to produce content characterization information associated with the content item; and
d) sending the content characterization information to the client device.

13. The method of claim 12 wherein b) includes downloading the content item from a remote content server over a network.

14. The method of claim 12 wherein b) includes retrieving the content item from a local storage device associated with the content characterization server.

15. The method of claim 12 wherein c) includes identifying a division between a main feature of the content item and an auxiliary feature of the content item, whereby the content characterization information identifies the division between a main feature of the content item and an auxiliary feature of the content item.

16. The method of claim 15 wherein the auxiliary feature includes an advertisement.

17. The method of claim 15 wherein c) includes identifying a beginning and an end of the auxiliary feature, whereby the content characterization information identifies the beginning and the end of the auxiliary feature of the content item.

18. The method of claim 15 wherein c) includes identifying an alternative auxiliary content item to replace the auxiliary feature from the content item, whereby the modified content item identifies the alternative auxiliary feature.

19. The method of claim 12, wherein c) includes associating a moderation criterion with a particular portion of the content item, whereby the content characterization information includes a content moderation criterion associated with a particular portion of the content item.

20. The method of claim 19 wherein moderation criterion is based on a degree of violence, adult language or adult nature of the particular portion.

21. The method of claim 12, wherein b) includes downloading the content item from a remote content server over the network, wherein a data transfer rate for downloading the content item is greater than a data transfer rate for which the client device can download the content item from the remote content server.

22. A content characterization server, comprising:
a processor;
a memory; and
one or more instructions embodied in memory for execution by the processor, the instructions being configured to implement a method for characterizing content for a media player associated with a client device, comprising, the method comprising:
a) receiving information from the client device, wherein the information identifies an item of content;
b) obtaining the content item;
c) analyzing the content item to produce content characterization information associated with the content item; and
d) sending the content characterization information to the client device.

23. The content characterization server of claim 22, further comprising a network interface coupled between the processor and a high-bandwidth datalink, wherein the high-bandwidth datalink is characterized by a data transfer rate for downloading the content item from a remote content server that is greater than a data transfer rate for which the client device can download the content item from the remote content server.

24. In a system having a client device and a content characterization server, a method for modifying content for a media player associated with the client device, comprising:
a) sending content identifying information from the client device to the content characterization server;
b) receiving the content identifying information at the content characterization server;
c) obtaining the content item with the content characterization server;
d) analyzing the content item to produce content characterization information associated with the content item; and
e) sending the content characterization information to the client device;
f) receiving content characterization information from the content characterization server at the client device;
g) obtaining the item of content from one or more content servers with the client device; and
h) modifying the item of content with the client device based on the content characterization information to produce a modified content item.

25. A content modification system, comprising:
one or more client devices; and
one or more content characterization servers,
wherein the client device is configured to send content identifying information to the content characterization server, wherein the content identifying information identifies an item of content to be presented with a media player associated with the client device;
wherein the content characterization server is configured to receive the content identifying information from the client device, obtaining the content item, analyze the content item to produce content characterization information associated with the content item, and send the content characterization information to the client device;
wherein the client device is further configured to receive the content characterization information from the content characterization server, obtain the item of content from one or more content servers; and modify the item of content with the client device based on the content characterization information to produce a modified content item.
